(19) United States
(12) Patent Application Publication
(10) Pub. No.: US 2006/0288196 A1
(43) Pub. Date: Dec. 21, 2006

(54) System and method for exploiting timing variability in a processor pipeline

(76) Inventors: Osman Unsal, Barcelona (ES); Xavier Vera, Barcelona (ES); Antonio Gonzalez, Barcelona (ES)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/157,320

(22) Filed: Jun. 20, 2005

(51) Int. Cl. G06F 9/00

(52) U.S. Cl. 712/235

(57) ABSTRACT

A processor including a pipeline for processing a plurality of instructions is disclosed. The pipeline comprises a plurality of stages. Each stage comprises a processing logic, and a control logic. The processing logic processes an input to produce an output. The control logic receives the output of the processing logic, and provides an intermediate and final output of the processing logic. The intermediate output is provided at a fraction of one cycle of a clock signal after receiving the input. The final output is produced at one cycle of a clock signal after receiving the input. The control logic also detects errors, and stalls the pipeline for one cycle of the clock signal when an error is detected.

### BACKGROUND

Embodiments of the invention relate to microprocessor architecture. More specifically, at least one embodiment of the invention relates to reducing latency within a microprocessor.

“Pipelining” is a term used to describe a technique in processors for performing various aspects of instructions concurrently (“in parallel”). A processor “pipeline” may consist of a sequence of various logical circuits for performing tasks, such as decoding an instruction and performing micro-operations (“uops”) corresponding to one or more instructions. Typically, an instruction contains one or more uops, each of which are responsible for performing various sub-tasks of the instruction when executed. Multiple pipelines may be used within a microprocessor, such that a correspondingly greater number of instructions may be performed concurrently within the processor, thereby providing greater processor throughput.

In pipelining, a task associated with an instruction or instructions can be performed in several stages by a number of functional units within a number of pipeline stages. For example, a processor pipeline may include stages for performing tasks, such as fetching an instruction, decoding an instruction, executing an instruction, and storing the results of executing an instruction. In general, each pipeline stage may receive input information relating to an instruction, from which the pipeline stage can generate output information, which may serve as inputs to a subsequent pipeline stage. Accordingly, pipelining enables multiple operations associated with multiple instructions to be performed concurrently, thereby enabling improved processor performance, at least in some cases, over non-pipelined processor architectures.

In some prior art pipeline architectures, synchronization among the pipeline stages can be achieved by using a common clock signal for each pipeline. The frequency of the common clock signal may be set according to a critical path delay, including some safety margin. However, the critical path delay may not remain constant throughout the operation of the pipeline due, in part, to variation in semiconductor manufacturing process parameters, device operating voltage, device temperature, and pipeline stage input values (PVTI). In order to account for PVTI variations, some prior art architectures set the common clock frequency to account for the worst-case critical path delay, which may result in setting the common clock to a frequency slightly or significantly lower than that necessary to accommodate the worst-case critical path delay.

As semiconductor device sizes continue to scale lower in size, PVTI-related variability and corresponding safety margins may increase to accommodate the worst-case critical path delay. For example, for semiconductor process technology, such as technology in which a minimum device dimension is below 90 nanometers (nm), PVTI variations may contribute substantially to a critical path delay between pipeline stages. However, delay experienced by information propagated among the various pipeline stages may be smaller than worst-case critical path delays in a typical situation, due in part to the fact that worst-case PVTI delay conditions may not occur as frequently as less-than worst-case PVTI conditions. Therefore, pipelined processing architectures, in which a clock for synchronizing the pipeline stages is set according to a worst-case critical path delay, may operate at relatively low performance levels.

Furthermore, prior art architectures, in which a clock synchronizing the various pipeline stages is set according to a more common-case delay through the pipeline, must typically operate two copies of the pipeline at half-speed, wherein the two copies of the pipelines operate asynchronously with each other. Unlike prior art architectures, which use worst-case critical path delays as a basis for the common clock frequency, however, an input to a pipeline stage of one pipeline in a so-called “common-case clock” pipeline architecture does not typically depend upon the output of a previous pipeline stage of the other pipeline (i.e., there typically is no “bypass” from one stage to another). Therefore, the “common-case” clocked pipeline architecture may use two clocks to synchronize the two pipelines, respectively, that may have the same frequency and be out of phase with each other. Moreover, common-case clock pipeline architectures typically incur more cost in terms of die real estate and power consumption, as they require the processor pipeline to be duplicated.

### BRIEF DESCRIPTION OF THE DRAWINGS

The preferred embodiments of the invention will hereinafter be described in conjunction with the appended drawings provided to illustrate and not to limit the invention, wherein like designations denote like elements, and in which:

FIG. 1 is a flowchart depicting a method for processing an instruction in a pipeline of a processor, in accordance with an embodiment of the invention.

FIG. 2 is a block diagram of a pipeline stage of a pipeline, in accordance with an embodiment of the invention.

FIG. 3 depicts clock pulses, in accordance with an embodiment of the invention.

FIG. 4 is a block diagram of a two-stage pipeline of a processor, in accordance with an embodiment of the invention.

FIG. 5 is a table for depicting timing behavior of execution of instructions in a pipeline for a common-case delay, in accordance with an embodiment of the invention.

FIG. 6 is a table for depicting timing behavior of execution of instructions in a pipeline for detection and correction of errors, in accordance with an embodiment of the invention.

FIG. 7 is a block diagram of a pipeline array of a processor, in accordance with an embodiment of the invention.

FIG. 8 depicts clocking of pipeline stages of an exemplary pipeline array that is configured to run at four times frequency of a clock, in accordance with an embodiment of the invention.

### DETAILED DESCRIPTION

At least one embodiment of the invention relates to a processor having a number of pipeline stages and a technique for processing one or more operations prescribed by an instruction, instructions, or portion of an instruction within the processor using one or more processing pipelines having one or more pipeline stages. Advantageously, at least some embodiments of the invention can reduce latency of performing an operation within a processor pipeline.

Moreover, embodiments of the invention may reduce latency within one or more processing pipelines by exploiting the fact that a common-case delay of an instruction, instructions, or portion of an instruction in propagating among the stages of a processor pipeline is typically less than the corresponding worst-case critical path delay of the pipeline. In one embodiment of the invention, the frequency of the clock or clocks used to synchronize the pipeline stages may be set according to the worst-case critical path delay of a processing pipeline, while enabling stages of the pipeline to yield a correct result, or “output”, in less than a full period of the clock.

In at least one embodiment of the invention, a pipeline stage may speculatively generate an output result (“speculative output”) based on input information to the pipeline stage within one clock period. Furthermore, in at least one embodiment, a mis-speculated output of a pipeline stage may be corrected. In one embodiment, speculative processing in a pipeline stage may be performed by using intermediately generated output results (“intermediate output”) of the pipeline stage, which may be observed within one period, or “cycle”, of the clock signal, and typically substantially around half of a clock cycle.

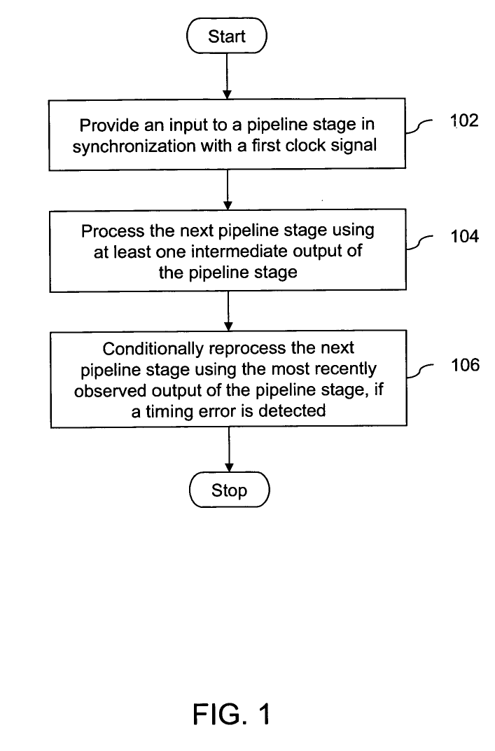

FIG. 1 is a flowchart depicting a method for processing an instruction in a pipeline of the processor, in accordance with an embodiment of the invention. The method is described in conjunction with two pipeline stages of a processor pipeline. The pipeline stages are synchronized by a first clock signal, wherein the frequency of the first clock signal is selected according to the worst-case critical path delay of the processor pipeline, including a delay margin. Accordingly, each stage in the pipeline may produce a correct output within one period of the first clock signal. At operation 102, an input is provided to a first pipeline stage in a manner substantially synchronized with the first clock signal. In one embodiment, the input to the pipeline stage is provided with enough set-up and hold time to be latched within the stage by a rising edge of the first clock signal. At operation 104, the subsequent pipeline stage generates an output based, at least in part, on one intermediate output of the first pipeline stage, which may be generated by the first pipeline stage within one period of the first clock signal, and in some cases substantially around one half of a first clock cycle. The intermediate output may also be stored so that it may be compared with subsequent worst-case delay outputs of the first pipeline stage, which are expected to be correct. In one embodiment, a most-recent output of the first pipeline stage may be indicated as such when stored by, for example, a bit or group of bits associated with the most-recent output.

Further at 106, the subsequent pipeline stage may re-process the most recent output of the first pipeline stage (e.g., the worst-case delay output), if an error is detected in the earlier intermediate output of the first stage.

In one embodiment, an error may be detected by comparing the most recent output of the first stage to the earlier intermediate output provided to the subsequent pipeline stage for speculative processing. If the most recent output and the intermediate output of the first stage do not match, an error is detected. If an error is detected, the error is corrected, in one embodiment, by providing the most recent output of the first stage, which is expected to be correct, to the input of the subsequent stage. In one embodiment, the most recent output of the first stage may be stored to compare with subsequent outputs of the first stage. Operation 106 may be performed a number of times for a number of intermediate outputs of the first stage. However, in one embodiment, the operation described in 106 is performed only until an output is received by the subsequent stage that is deemed to be the correct output (e.g., the worst-case delay output).

Some embodiments of the invention described herein relate to a multiple instruction issue, in-order pipeline architecture. In one embodiment, in particular, an in-order pipeline architecture has five stages: a fetch stage, a decode stage, an execute stage, a memory access, and memory writeback. However, other embodiments of the invention may also be used in other processor architectures, such as those using an out-of-order processing pipeline, in which instructions or uops are executed out of program order.

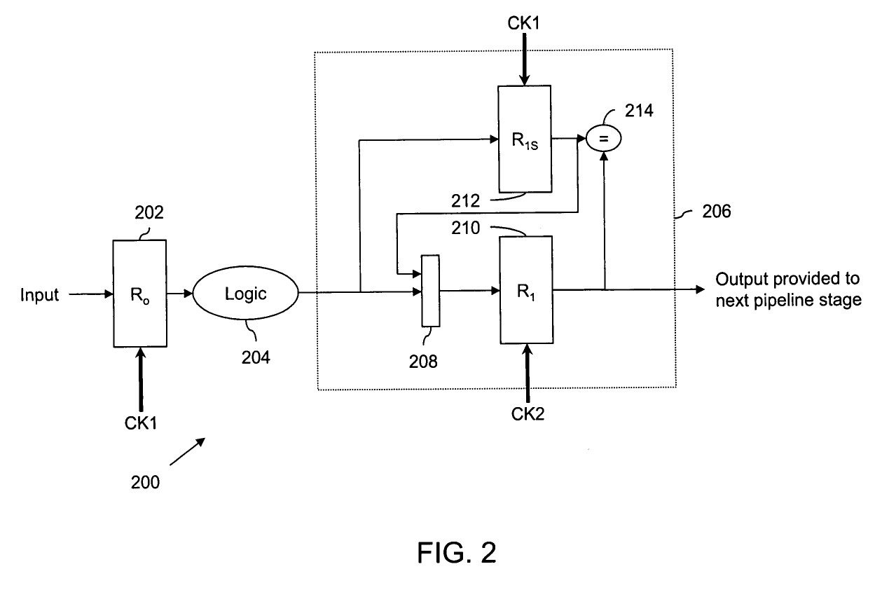

Various implementations of the embodiment described in conjunction with FIG. 1 are possible. One such implementation is hereinafter described with reference to FIG. 2.

FIG. 2 is a block diagram of a pipeline stage 200 of a processor pipeline, in accordance with one embodiment of the invention. Pipeline stage 200 comprises an input logic 202, a processing logic 204, and a control logic 206. Control logic 206 further comprises a selection logic 208, a first storage circuit 210, a second storage circuit 212, and an error detection logic 214. Input logic 202 is to receive the input to pipeline stage 200. The input is to be processed by processing logic 204, and the output values produced by the processing logic may be stored in the first storage circuit 210 through selection logic 208, and to second storage circuit 212. In one embodiment of the invention, first storage circuit 210 and second storage circuit 212 are latches.

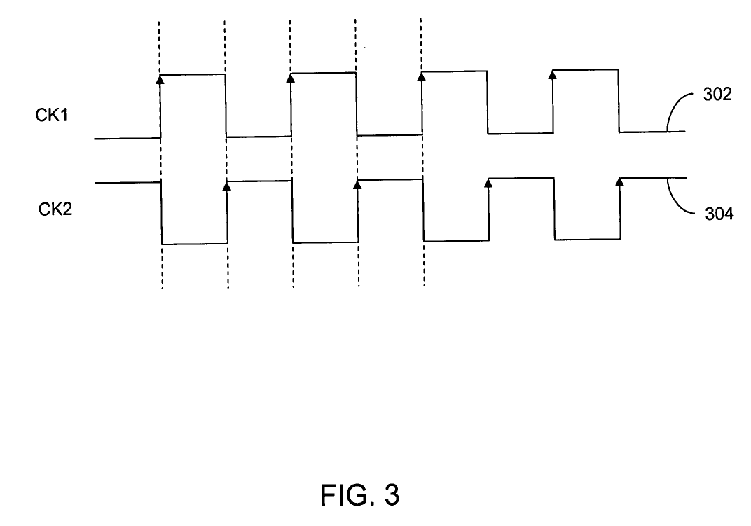

The first and second latches may store a logical value presented to the latch inputs with enough setup and hold time to be latched by a clock signal. Furthermore the first and second latches may output a logical value when triggered by a clock signal and thereafter maintain the value for a subsequent circuit to receive until a new value is presented to the latch with enough setup and hold time to be latched by a clock signal. In one embodiment of the invention, the latches are triggered by a rising edge of a clock signal, such as the clock signal shown in FIG. 3.

In one embodiment, the first storage circuit 210 stores the output of the processing logic and provides the output to a subsequent pipeline stage so that the subsequent pipeline stage may speculatively process the output of the processing logic. The second storage circuit 212 may store the most recent output of the processing logic, which in some embodiments may correspond to the correct output (e.g., worst-case delay output).

In one embodiment, error detection logic 214 compares the values stored in first storage circuit 210 and second storage circuit 212 in order to detect the occurrence of an error in the output of the pipeline stage. Error detection logic 214 may also provide an error signal (not shown) to selection logic 208. Therefore, while an error in the output of the pipeline stage is not detected, selection logic 208 provides the output of processing logic 204 to first storage circuit 210. However, if an error in the output of the pipeline stage is detected, selection logic provides the value stored in second storage circuit 212 to first storage circuit 210, in one embodiment.

In one embodiment of the invention, pipeline stage 200 uses clock signals CK1 and CK2 to synchronize the various latches illustrated in FIG. 2. In one embodiment, CK1 and CK2 may have the same frequency, but may differ in phase by, for example, 180 degrees. In one embodiment, CK1 and CK2 may be derived from the same clock or from different clocks with CK2 being 180 degrees out of phase with respect to CK1. In another embodiment of the invention, CK1 and CK2 have the same frequency, but may differ in phase by some lesser amount, such as by 90 degrees. In one embodiment, CK1 and CK2 may be derived from the same clock or from different clocks with CK2 being 90 degrees out of phase with respect to CK1. In other embodiments, four clock signals (two or more being derived from the same or different clocks) can be used, each differing in phase by 90 degrees. In one embodiment, the four clock signals may be derived from the same clock with the second, third, and fourth clock signals being shifted in phase by 90, 180, and 270, respectively, with respect to the first clock signal.

In one embodiment, input logic 202, first storage circuit 210 and second storage circuit 212 are triggered on the rising edge of a clock signal. In other embodiments, any of the input logic, first storage circuit, and second storage circuit may be triggered by the falling edge of a clock signal. In one embodiment, input logic 202 provides the input to processing logic 204 with enough setup and hold time to be latched with a first rising edge of CK1 (denoted by CK1¹). Processing logic 204 may process the input, to produce a correct output before the second rising edge of CK1 (denoted by CK1²). First storage circuit 210 stores an intermediate output of processing logic 204 when triggered by a rising edge of CK2 (denoted by CK2¹) that succeeds CK1¹. The intermediate output is provided to the subsequent pipeline stage in the pipeline array for further processing. However, the intermediate output is a speculative output that may be determined to be incorrect. The second storage circuit 212 stores the output of processing logic 204 that is expected to be correct (e.g., worst-case delay output) when the second storage circuit 212 is triggered by CK1². In one embodiment, error detection logic 214 compares the intermediate output stored in first storage circuit 210 with the output expected to be correct, stored in second storage circuit 212, to detect the occurrence of an error in the generation of the intermediate output by the processing logic 204. If no error is detected, the error signal may be set a value to cause selection logic 208 to continue to provide the output of processing logic 204 to first storage circuit 210. On the other hand, if an error is detected by error detection logic 214, the error signal may be set to instruct selection logic 208 to provide the expected correct output stored in second storage circuit 212 to first storage circuit 210.

In one embodiment, the error signal also causes the processing pipeline to stall in order to recover from the error. In one embodiment, the pipeline is stalled for a full cycle, allowing the speculatively generated intermediate value to be removed from the pipeline (“squashed”), including processing logic and storage circuits, and the expected correct value to be delivered to appropriate pipeline stage. At the second rising edge of CK2 (denoted by CK2²), the expected correct value is stored in first storage circuit 210, and provided to the subsequent pipeline stage for processing. After the expected correct output is stored in first storage circuit 210, error detection logic 214 ceases to detect the error resulting from the mis-speculated intermediate output, and the processing pipeline may resume operation.

Although embodiments discussed in reference to FIG. 2 use two clocks and rising-edge triggered storage circuits, in another embodiment of the invention, input logic 202, first storage circuit 210, and second storage circuit 212 may only be triggered by CK1 if input logic 202 and second storage circuit 212 are rising-edge triggered, and first storage circuit 210 is falling-edge triggered, for example. In some embodiments, input logic 202, first storage circuit 210, and second storage circuit 212 may include registers, latches, or flip-flops, whereas in other embodiments these circuits may include other hardware logic that performs substantially the same function.

FIG. 3 depicts the clock pulses of CK1 and CK2, in accordance with an embodiment of the invention. Waveform 302 depicts the first clock signal CK1, and waveform 304 depicts the second clock signal CK2. In both the waveforms, arrows pointing vertically upwards depict the rising edges of the clock pulses. In the embodiment illustrated in FIG. 3, CK2 is delayed by a phase angle of 180 degrees from CK1. In an embodiment of the invention, clock pulses CK1 and CK2 are derived from the same clock, whereas in other embodiments CK1 and CK2 may be derived from separate clocks.

Pipeline stage 200 described above may double the processing throughput of the stage in relation to some embodiments of the invention by using two clocks differing in phase by 180 degrees. In another embodiment of the invention, pipeline stage 200 achieves even greater throughput by decreasing the phase difference of the two clocks or by using more clocks shifted in phase by smaller amounts. In one embodiment, pipeline stage throughput is increased by using two clocks differing in phase by 90 degrees. For example, in one embodiment, the throughput is quadrupled when CK1 and CK2 differ by a phase of 90 degrees. In this case, the intermediate output can be provided to the next pipeline stage for speculative processing in one-fourth the clock period of CK1 or CK2. However, the expected correct output (e.g., worse-case delay output) may be available after the full clock cycle. Therefore, pipeline stage 200 operates at four times the throughput when there are no errors in the intermediate outputs. If an error occurs, pipeline stage 200 may be stalled for a full cycle as described earlier.

Embodiments previously described may reduce pipeline latency and increase the throughput of the pipeline. Furthermore, in embodiments previously described, errors in pipeline stage output due to delays within the pipeline stages being greater than some common-case delay may be detected and corrected. Other subsequent pipeline stages may be coupled to pipeline stage 200 and the techniques previously described may be extended to the other subsequent pipeline stages, such that the same benefits described above may be achieved for the other subsequent pipeline stages.

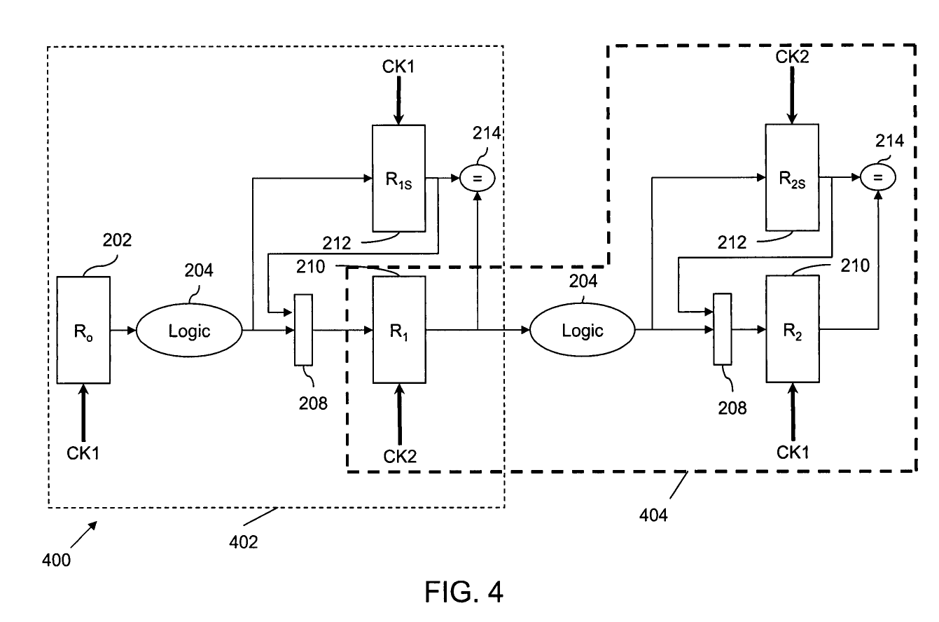

For example, FIG. 4 is a block diagram of a two-stage pipeline 400 of a processor, in accordance with an embodiment of the invention. Pipeline 400 includes a first stage 402 (depicted by dashed lines), and a second stage 404 (depicted by bold dashed lines). In one embodiment, the two-stage pipeline illustrated in FIG. 4 may operate using similar principals described in regard to pipeline stage 200 in FIG. 2. In the embodiment illustrated in FIG. 4, instructions may be passed serially from stage 402 to stage 404. In one embodiment, the first storage circuit 210 of stage 402 (hereinafter R₁) is also the input logic for stage 404. Also, in FIG. 4, R₁ is clocked by CK2, while first storage circuit 210 of stage 404 (hereinafter R₂) is clocked by CK1. This clocking scheme enables the throughput of pipeline 400 to be doubled at every subsequent pipeline stage.

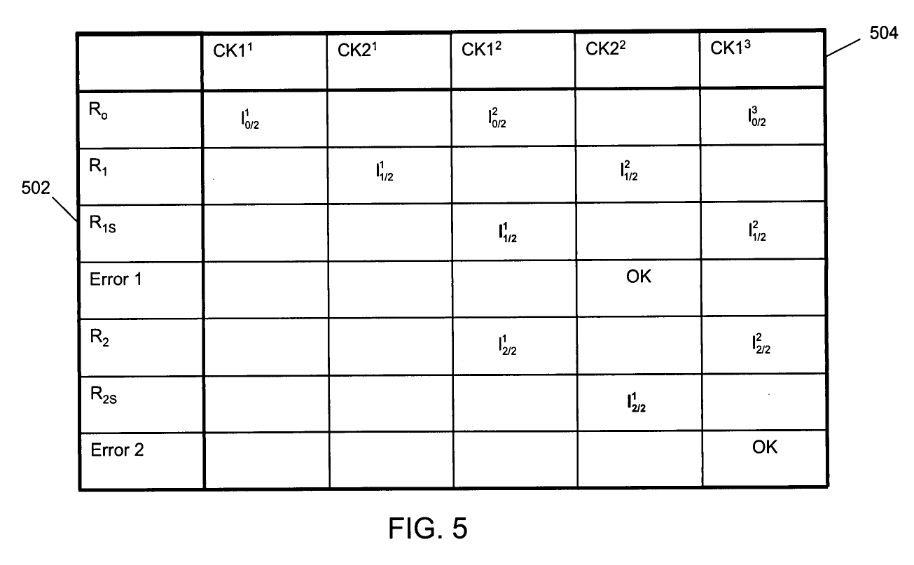

FIG. 5 is a table illustrating the timing behavior of execution of the instructions in pipeline 400 in an embodiment in which each pipeline stage exhibits a common-case throughput delay. Specifically, the table of FIG. 5 shows result of latching instructions delivered through the pipeline of FIG. 4 with clocks CK1 and CK2 in the case that each pipeline stage is able to generate an output from a corresponding input within or substantially in proximity to a common-case delay that is less than (e.g., half) of a worst-case delay of each stage. The input and storage circuits are shown in column 502, while the clock stages are depicted in row 504. In the embodiment illustrated in FIG. 5, each instruction is divided into two stages. The first stage of the instruction is executed by pipeline stage 402, and the second stage is executed by pipeline stage 404. In the table, an instruction is denoted by I_{M/2}^{N}, where N is the instruction number and M is the stage of the corresponding instruction. For example, the notation I_{1/2}³ denotes the first stage of the third instruction. The instructions denoted in bold letters represent the results latched in second storage circuits 212. In one embodiment, the table illustrates that the throughput of the pipeline of FIG. 4 is twice that of an embodiment in which outputs are only latched after a worst-case delay of each pipeline stage for the same clock frequency. For example, I_{1/2}¹ is latched in R₁ at CK2¹, processed, and the result is latched in R₂ at CK1² (i.e., after half a clock cycle).

If no errors occur, (i.e., the value latched in R_{1S} at CK1² is equal to the value latched in R₁ at CK2¹) then I_{2/2}¹ is latched in R_{2S} at CK2², and I_{1/2}² is latched in R₁ at CK2². However, if an error occurs, (i.e., the value latched in R_{1S} at CK1² does not equal the value latched in R₁ at CK2¹) the error is detected and corrected by stalling the pipeline by a full clock cycle such that I_{1/2}¹ may be latched in R₁ at CK2².

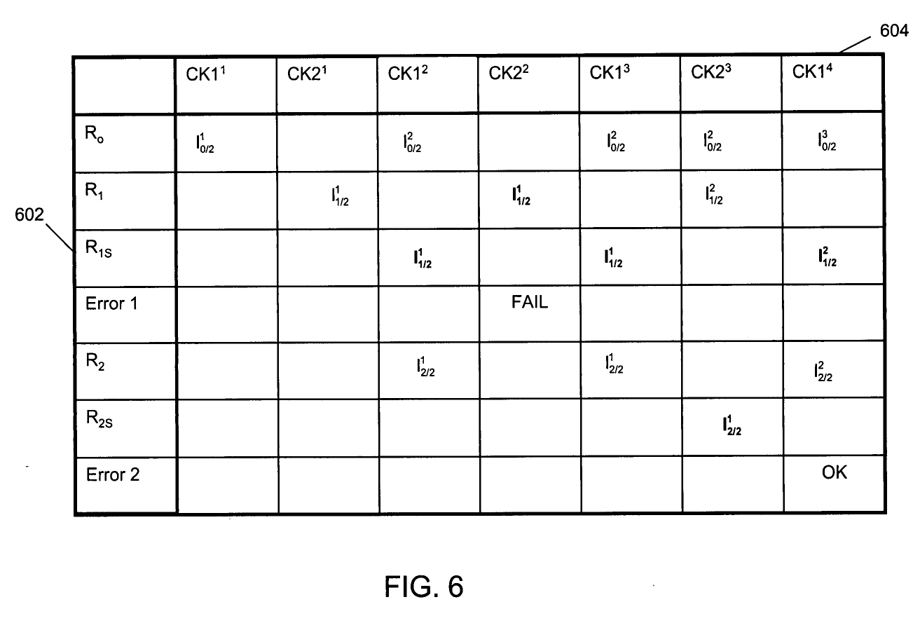

FIG. 6 is a table illustrating the timing behavior for processing instructions in pipeline 400 in the case that errors are detected and corrected. Specifically, FIG. 6 depicts the case when an error occurs in the first stage of pipeline 400. The input and storage circuits are shown in column 602, while the clock stages are depicted in row 604. FIG. 6 illustrates an incorrect output value latched in R₁ at CK2¹. The resulting error is detected during the transition from CK1² to CK2², allowing reloading of R₁ with the correct value. Rₒ is stalled for one cycle so that the next instruction is not lost, and the values latched in R₂ and R_{2S} are indicated to be invalid by some indication, such as a bit or group of bits associated with the erroneous values. Therefore, the correct result from the first stage is available at CK1³.

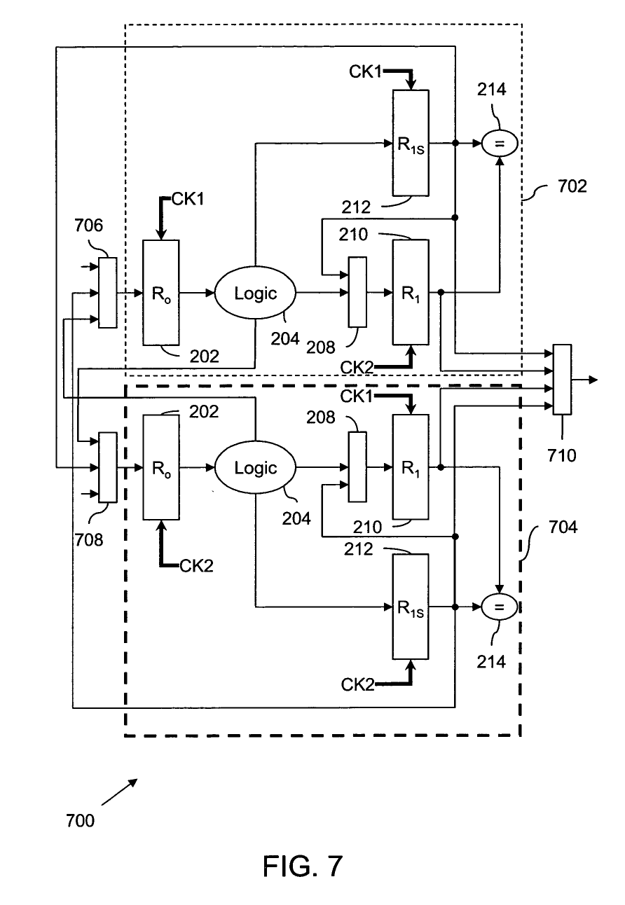

FIG. 7 is a block diagram of a pipeline array 700 within a processor, in accordance with one embodiment of the invention. Pipeline array 700 includes a first pipeline having a first pipeline stage 702, a second pipeline having a second pipeline stage 704, a first selection logic 706, a second selection logic 708, and a third selection logic 710. In one embodiment, the two pipelines work in parallel with each other. In other words, instructions may be processed within the pipeline array of FIG. 7 concurrently in both the pipelines. Furthermore, each pipeline may have multiple stages interconnected in series in one embodiment.

The operation of each pipeline stage of FIG. 7 is similar to that of pipeline stage 200 shown in FIG. 2. For example, selection logic 706 may select the input and provides it to input logic 202 of first pipeline stage 702. Once the input is stored in input logic 202, it may be processed by processing logic 204, the result of which may be provided to input logic 202 of the second pipeline stage through second selection logic 708. By providing the output of processing logic 204 to input logic 202 of the second pipeline stage, the pipeline array of FIG. 7 may achieve higher throughput if output values are latched from processing logic 204 after a common-case delay rather than after a worst-case delay.

However, if an error occurs in the output of processing logic 204, the expected correct output stored in second storage circuit 212 of first pipeline stage 702 is passed to input logic 202 of the second pipeline stage 704 through second selection logic 708 of the pipeline array. First selection logic 706 may work in a similar manner as described above, which enables the pipeline array 700 to function in a manner described earlier. Further, a third selection logic 710 can select any one of the outputs from among the outputs of all the storage circuits of FIG. 7, and the selected output may be passed on to the next stages. For example, for a common-case delay among the processing logic of FIG. 7, the result from first storage circuit 210 of pipeline stage 702 is selected as input to a next stage (not shown in FIG. 7) whose input logic can be clocked by CK2. In case of an error, the result from second storage circuit 212 of pipeline stage 702 is selected. Similarly, the result from first storage circuit 210 of pipeline stage 704 is selected as input to the next stage (not shown in FIG. 7) whose input logic is clocked by CK2, for a common-case delay among the processing logic of FIG. 7. In case of an error, the result from second storage circuit 212 of pipeline stage 704 is selected in one embodiment.

In one embodiment, the third selection logic, illustrated in FIG. 7, receives the intermediate output of the first stage, the final output of the first stage, the intermediate output of the second stage, and the final output of the second stage. The third selection logic outputs the intermediate output of the first stage at each first point in the second clock cycle if no error is detected by the error detection logic of the first stage, the third selection logic outputs the final output of the first stage at each first point in the first clock cycle if an error is detected by the error detection logic of the first stage, the third selection logic outputs the intermediate input of the second stage to the next stage at each first point in the first clock cycle if no error is detected by the error detection logic of the second stage, and the third selection logic outputs the final output of the second stage at each first point in the second clock cycle if an error is detected by the error detection logic of the second stage.

In some embodiments of the invention, a pipeline or pipeline array may operate without using selection logic 208, second storage circuit 212, or error detection logic 214 if there is no phase difference between CK2 and CK1. Furthermore, in one embodiment, a pipeline may use arithmetic logic unit (ALU) result value loopback buses to provide output of one stage to another, thereby enabling relatively expedient movement of data through the pipeline stages. In an embodiment of the invention, the number of errors in a pipeline array is monitored and if the number of errors is found to be greater than a particular threshold number of errors, then the pipeline array may be reconfigured to operate in a manner such that output data from each pipeline stage is latched after a worst-case delay through the stage logic. In an embodiment in which the pipeline or pipeline array is reconfigured to latch data after a worst-case delay, each reconfigured pipeline stage may comprise an input logic 202 and first storage circuit 210, both of which are clocked by the same clock.

For the sake of illustration, only two stages are shown in pipeline 400 and pipeline array 700. In general, however, the number of stages may be higher depending on the number of instructions to be executed simultaneously or other considerations. Further, both pipeline 400 and pipeline array 700 make use of two clocks in one embodiment. However, the number of clocks may be higher depending on the desirable pipeline throughput. In an embodiment of the invention, the throughput through each pipeline stage is up to four times the clock frequency.

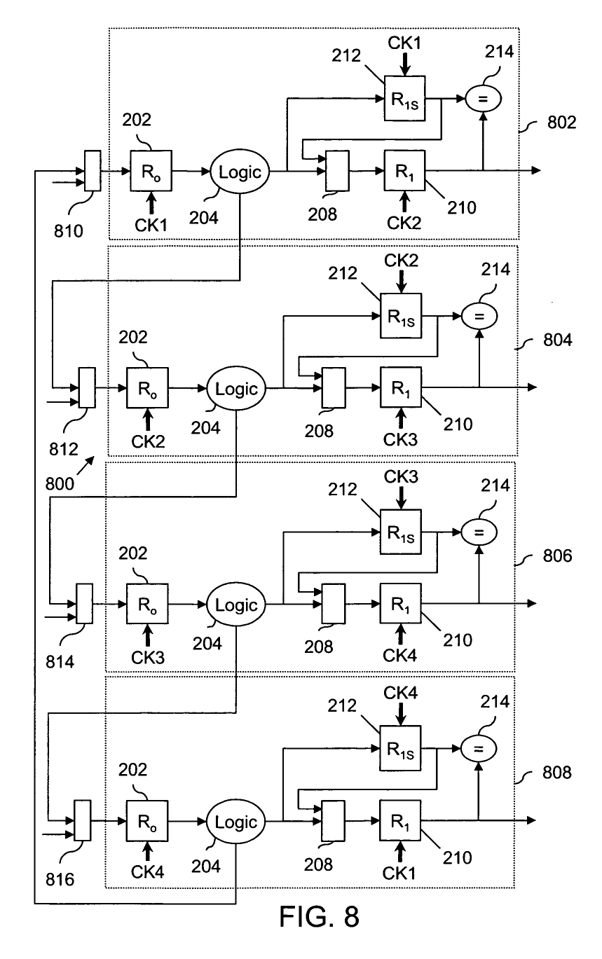

FIG. 8 depicts an exemplary pipeline array 800 that may operate at four times the frequency of the clock, in accordance with an embodiment of the invention. Pipeline array 800 includes a first pipeline stage 802, a second pipeline stage 804, a third pipeline stage 806, and a fourth pipeline stage 808. The pipeline stages of FIG. 8 can process instructions in a “chain mode”, which is similar to the operation of the example shown in FIG. 4. The pipeline stages can also process instructions in a manner similar to the operation of the example shown in FIG. 7. Further, instructions can be bypassed from one stage to another stage for simplifying the scheduling of execution of the instructions.

In the embodiment illustrated in FIG. 8, four clocks, i.e., CK1, CK2, CK3, and CK4 are used for clocking the pipeline stages of pipeline array 800. In an embodiment of the invention, the clocks have the same frequency but differ in phase by 90 degrees from each other. For example, if the phase of CK1 is θ degrees, then the phase of CK2 is θ-90 degrees, CK3 is θ-180 degrees, and CK4 is θ-270 degrees. In first pipeline stage 802, CK1 clocks input logic 202 and second storage circuit 212, and CK2 clocks first storage circuit 210. In second pipeline stage 804, CK2 clocks input logic 202 and second storage circuit 212, and CK3 clocks first storage circuit 210. In third pipeline stage 806, CK3 clocks input logic 202 and second storage circuit 212, and CK4 clocks first storage circuit 210. Similarly in fourth pipeline stage 808, CK4 clocks input logic 202 and second storage circuit 212, and CK1 clocks first storage circuit 210, such that the intermediate output of a pipeline stage is input to another pipeline stage at the triggering edge of the same clock.

For example, an intermediate output may be stored in first storage circuit 210 of second pipeline stage 804 at the triggering edge of CK3. The intermediate output may also be provided as input to input logic 202 of third pipeline stage 806 at the triggering edge of CK3. The intermediate output is provided by a selection logic 814. In one embodiment, instructions are bypassed to a subsequent stage every one-fourth clock cycle of the clocks if no errors occur, and the throughput is quadrupled. If an error occurs, the pipeline may be stalled for three clock cycles at four times the clock frequency or until the error is resolved.

Although various embodiments of the invention have been described with respect to two and four storage circuits, the number of storage circuits that are clocked by simultaneous phase-delayed clock pulses can vary depending on the difference between the common-case delay and the worst-case delay.

Embodiments of the invention may reduce latency in one or more processor pipelines. Furthermore, throughput of a pipeline stage may be increased by varying the number of clocks in some embodiments. In at least one embodiment, errors in a speculative pipeline stage output due to worst-case delays through a processing stage or processing stage delays otherwise greater than a more common-case delay may be detected and subsequently corrected by using a worst-case delay output from the erroneous stage.

Embodiments of the invention may be implemented in hardware logic in some embodiments, such as a microprocessor, application specific integrated circuits, programmable logic devices, field programmable gate arrays, printed circuit boards, or other circuits. Furthermore, various components in various embodiment of the invention may be coupled in various ways, including through hardware interconnect or via a wireless interconnect, such as radio frequency carrier wave, or other wireless means.

Further, at least some aspects of some embodiment of the invention may be implemented by using software or some combination of software and hardware. In one embodiment, software may include a machine readable medium having stored thereon a set of instructions, which if performed by a machine, such as a processor, perform a method comprising operations commensurate with an embodiment of the invention.

While the various embodiments of the invention have been illustrated and described, it will be clear that the invention is not limited to these embodiments only. Numerous modifications, changes, variations, substitutions and equivalents will be apparent to those skilled in the art without departing from the spirit and scope of the invention as described in the claims.

What is claimed is:

1. A processor comprising:
a comparison logic to compare a speculative output of a pipeline stage with an expected output from the pipeline stage to determine whether the speculative output is the same as the expected output.

2. The processor of claim 1 wherein the comparison logic comprises a first storage unit to store the speculative output in response to a first clock edge and a second storage unit to store the expected output in response to a second clock edge.

3. The processor of claim 2 wherein the first clock edge corresponds to a first clock signal and the second clock edge corresponds to a second clock signal.

4. The processor of claim 3 wherein the first clock is 180 degrees out of phase with respect to the second clock signal.

5. The processor of claim 4 wherein the first clock edge and the second clock edge are both rising edges.

6. The processor of claim 4 wherein the first clock edge and second clock edge are both falling edges.

7. The processor of claim 2 wherein the first clock edge is a rising edge and the second clock edge is a falling edge.

8. The processor of claim 4 wherein the first and second storage units include an edge-triggered latch.

9. An apparatus comprising:
a plurality of processing stages including:
an input circuit to store an input data in response to detecting a first clock edge of a first clock signal;
a processing logic to generate an intermediate output data for a subsequent processing stage in response to the input data and before a third edge of the first clock signal, the third edge being one clock cycle from the first clock edge;
comparison logic to compare the intermediate output with the final output.

10. The apparatus of claim 9 wherein the plurality of processing stages are to stall for no more than one cycle of the first clock signal if the intermediate output is not the same as the final output.

11. The apparatus of claim 9 wherein the final output is to be provided to the subsequent stage only if the intermediate output is not the same as the final output.

12. The apparatus of claim 9 wherein the comparison logic comprises a first storage unit to store the intermediate output in response to a second clock edge of a second clock signal and a second storage unit to store the final output in response to the third clock edge of the first clock signal.

13. The apparatus of claim 12 wherein the first clock is 180 degrees out of phase with respect to the second clock signal.

14. The apparatus of claim 12 wherein the first clock signal is 90 degrees out of phase with respect to the second clock signal.

15. The apparatus of claim 12 further comprising a selection logic to provide the output of the processing logic to the first storage unit if the intermediate output is the same as the final output.

16. The apparatus of claim 15 wherein the selection logic is to provide the final output from the second storage unit to the first storage unit if the intermediate output is not the same as final output.

17. A system comprising:
a memory to store an instruction;
a processor to stall in response to a first pipeline stage generating an incorrect speculative output as a result of performing a portion of the instruction, wherein the processor comprises a first comparison logic to compare a speculative output of the first pipeline stage with an expected output from the first pipeline stage to determine whether they are the same.

18. The system of claim 17 wherein the comparison logic comprises a first storage unit to store the speculative output of the first pipeline stage in response to a first clock edge of a first clock signal and a second storage unit to store the expected output of the first pipeline stage in response to a second clock edge of a second clock signal.

19. The system of claim 18 further comprising a second pipeline stage including a second comparison logic comprising a third storage unit to store a speculative output of the second pipeline stage in response to a third clock edge of a third clock signal and a fourth storage unit to store the expected output of the second pipeline stage in response to the second clock edge of the second clock signal.

20. The system of claim 19 further comprising a third pipeline stage including a third comparison logic comprising a fourth storage unit to store a speculative output of the third pipeline stage in response to a fourth clock edge of a fourth clock signal and a fifth storage unit to store the expected output of the third pipeline stage in response to the third clock edge of the third clock signal.

21. The system of claim 20 further comprising a fourth pipeline stage including a fourth comparison logic comprising a fifth storage unit to store a speculative output of the fourth pipeline stage in response to a fifth clock edge of a fifth clock signal and a sixth storage unit to store the expected output of the fourth pipeline stage in response to the fourth clock edge of the fourth clock signal.

22. The system of claim 18 wherein the first clock is 180 degrees out of phase with respect to the second clock signal.

23. The system of claim 21 wherein the first clock is 90 degrees out of phase with respect to the second clock signal, the second clock signal is 90 degrees out of phase with respect to the third clock signal, and the third clocks signal is 90 degrees out of phase with the fourth clock signal.

24. The system of claim 23 wherein the first, second, third, fourth, fifth, and sixth storage units may be chosen from a group consisting of: a latch, a flip-flop, a register.

25. A method comprising:
providing an intermediate output of a processing logic to a next stage by using a second clock signal;
providing a final output of the processing logic using a first clock signal, wherein the second clock signal is out of phase with the first clock signal, wherein clock cycle lengths of the first clock signal and the second clock signal are equal;
comparing the intermediate output with the final output for error detection;
performing error recovery if an error is detected, wherein the error recovery comprises stalling the pipeline by one clock cycle and providing the final output to the next stage by using the second clock signal.

26. The method of claim 25, wherein the input is received by the processing logic substantially coincident with a triggering point in the first clock signal.

27. The method of claim 25, wherein providing the intermediate output of the processing logic to the next stage includes clocking a first storage circuit by the second clock signal, selecting the output of the processing logic by a selection logic if no error is detected, and providing the output of the processing logic to the first storage circuit substantially coincident with a triggering point in the second clock signal.

28. The method of claim 25, wherein providing the final output of the processing logic includes clocking a second storage circuit by the first clock signal and providing the output of the processing logic to the second storage circuit substantially coincident with a triggering point in the first clock signal.

29. The method of claim 25, wherein the error is detected if the intermediate output is not equal to the final output.

30. The method of claim 25 wherein the error is not detected if the intermediate output is equal to the final output.
